(19) United States
(12) Patent Application Publication
(10) Pub. No.: US 2022/0162779 A1
(43) Pub. Date: May 26, 2022

(54) LOW FRICTION INFRARED-EMITTING FIBER AND METHODS OF MAKING THE SAME

(71) Applicant: Circufiber Inc., Cohasset, MA (US)

(72) Inventor: Zaev Samuel BASSIN, San Juan (PR)

(21) Appl. No.: 17/533,490

(22) Filed: Nov. 23, 2021

Related U.S. Application Data
(60) Provisional application No. 63/118,316, filed on Nov. 25, 2020.

(51) Int. Cl. D02G 3/04; D02G 3/44; C01B 35/14; D01F 8/08

(52) U.S. Cl. CPC D02G 3/045; D02G 3/44; B82Y 20/00; D01F 8/08; D10B 2331/02; C01B 35/146

(57) ABSTRACT

Infrared-emitting fiber composed of a polymer and having an emissivity of greater than or equal to 0.88 and a low coefficient of friction for making an article of apparel. In some embodiments, the polymer can have an emissivity of greater than or equal to 0.88. In some embodiments, the infrared-emitting fiber can include particles attached to the polymer and formed of a material comprising a kinetic coefficient of friction ranging from 0.1 to 0.7.

### CROSS-REFERENCE TO RELATED APPLICATIONS

This application claims priority to U.S. Provisional Application No. 63/118,316, filed Nov. 25, 2020, which is incorporated herein in its entirety by reference thereto.

### FIELD

This disclosure relates to infrared-emitting fiber. In particular embodiments, this disclosure relates to infrared-emitting fiber for making fabric for an article of apparel.

### BACKGROUND

Infrared-emitting textiles (also referred to “infrared textiles”) are becoming increasing prevalent in the clothing industry. Infrared textiles have shown the ability to increase microcirculation, speed healing, increase tissue oxygen, fight fatigue, and create thermal regulation in humans and animals.

There is a need for new infrared textiles that provide desired properties for users.

### BRIEF SUMMARY

The present disclosure is directed to infrared-emitting fiber having a low static and/or kinetic coefficient of friction. The low-friction fiber can be used to make a textile having a relatively low static and/or kinetic coefficient of friction. The low static and/or kinetic coefficient of friction of the textile can be beneficial for a variety of reasons, including user comfort, decreasing wear on manufacturing equipment, and increasing the efficiency of forming techniques used to make the textile (for example, weaving or knitting techniques).

A first aspect (1) of the present application is directed to an infrared-emitting fiber, the fiber comprising: a polymer comprising an emissivity of greater than or equal to 0.81, and particles attached to the polymer and formed of a material comprising a kinetic coefficient of friction ranging from 0.1 to 0.7.

In a second aspect (2), the polymer according to the first aspect (1) comprises an acrylic polymer.

In a third aspect (3), the polymer according to the first aspect (1) comprises an acrylonitrile polymer.

In a fourth aspect (4), the polymer according to the first aspect (1) comprises a nylon polymer.

In a fifth aspect (5), the particles according to any one of aspects (1)-(4) comprise particles selected from the group consisting of: boron nitride particles, graphite particles, tungsten disulfide particles, molybdenum disulfide particles, or polytetrafluoroethylene particles.

In a sixth aspect (6), the particles according to any one of aspects (1)-(5) comprise hexagonal boron nitride particles.

In a seventh aspect (7), the particles according to any one of aspects (1)-(6) comprise a mean particle size ranging from 50 nanometers to 1 micron.

In an eighth aspect (8), the infrared-emitting fiber according to any one of aspects (1)-(7) comprises 0.05 wt % to 1 wt % of the particles, based on total weight of the fiber.

In a ninth aspect (9), the infrared-emitting fiber of any one of aspects (1)-(7) comprises 0.15 wt % to 0.75 wt % of the particles, based on total weight of the fiber.

In a tenth aspect (10), the particles according to any one of aspects (1)-(9) are embedded in the polymer.

In an eleventh aspect (11), the infrared-emitting fiber of any one of aspects (1)-(10) further comprises infrared-emitting particles embedded in the polymer and formed of a material comprising an emissivity of greater than or equal to 0.90.

In a twelfth aspect (12), the infrared-emitting particles according to the eleventh aspect (11) are quartz particles.

In a thirtieth aspect (13), the infrared-emitting fiber according to the eleventh aspect (11) or the twelfth aspect (12) comprises 0.25 wt % to 0.5 wt % of the infrared-emitting particles, based on total weight of the fiber.

In a fourteenth aspect (14), the material forming the infrared-emitting particles according to any one of aspects (11)-(13) comprises a refractive index ranging from 1.37 to 1.67.

In a fifteenth aspect (15), the infrared-emitting fiber according to any one of aspects (1)-(14) further comprises a dispersant.

In a sixteenth aspect (16), the dispersant according to the fifteenth aspect (15) comprises a polyethylene wax.

In a seventeenth aspect (17), the infrared-emitting fiber according to the fifteenth aspect (15) or the sixteenth aspect (16) comprises 4 wt % to 10 wt % of the dispersant, based on total weight of the fiber.

In an eighteenth aspect (18), the polymer according to any one of aspects (1)-(17) comprises an emissivity of ranging from 0.81 to 0.91.

A nineteenth aspect (19) of the present application is directed to a yarn comprising the fiber of any one of aspects (1)-(18).

A twentieth aspect (20) of the present application is directed to an article of apparel comprising a fabric, the fabric comprising infrared-emitting fiber, the fiber comprising: a polymer comprising an emissivity of greater than or equal to 0.81, and particles attached to the polymer and formed of a material comprising a kinetic coefficient of friction ranging from 0.1 to 0.7; an emissivity of greater than or equal to 0.88; and at least one of: a static coefficient of friction of 0.21 or less, or a kinetic coefficient of friction of 0.22 or less.

In a twenty-first aspect (21), the fabric according to the twentieth aspect (20) comprises a kinetic coefficient of friction of 0.22 or less.

In a twenty-second aspect (22), the article of apparel according to the twentieth aspect (20) or the twenty-first aspect (21) comprises a hollow shape defined by a textile material and the fabric defines at least a portion of the textile material.

In a twenty-third aspect (23), the article of apparel according to any one of aspects (20)-(22) comprises a sock.

In a twenty-fourth aspect (24), the article of apparel according to any one of aspects (20)-(22) comprises a sleeve.

A twenty-fifth aspect (25) of the present application is directed to an article of apparel comprising a fabric, the fabric comprising infrared-emitting fiber, the fiber comprising: a polymer comprising an emissivity of greater than or equal to 0.81, and particles attached to the polymer and formed of a material comprising a kinetic coefficient of friction ranging from 0.1 to 0.7; an emissivity of greater than or equal to 0.88; and at least one of: a static coefficient of friction of 0.22 or less, or a kinetic coefficient of friction of 0.30 or less.

In a twenty-sixth aspect (26), the fabric according to the twenty-fifth aspect (25) comprises a kinetic coefficient of friction of 0.30 or less.

In a twenty-seventh aspect (27), the article of apparel according to the twenty-fifth aspect (25) or the twenty-sixth aspect (26) comprises a hollow shape defined by a textile material and the fabric defines at least a portion of the textile material.

In a twenty-eighth aspect (28), the article of apparel of any one of aspects (25)-(27) comprises a sock.

In a twenty-ninth aspect (29), the article of apparel according to any one of aspects (25)-(27) comprises a sleeve.

A thirtieth aspect (30) of the present application is directed to a method of making infrared-emitting fiber, the method comprising: mixing monomers and particles in an aqueous solution, where the particles are formed of a material comprising a kinetic coefficient of friction ranging from 0.1 to 0.7; polymerizing the monomers in the aqueous solution comprising the particles to form a polymer; dissolving the polymer using a solvent to form a polymer solution; and forming the polymer solution into the infrared-emitting fiber.

In a thirty-first aspect (31), forming the polymer solution into the infrared-emitting fiber according to the thirtieth aspect (30) comprises removing the solvent from the polymer solution.

In a thirty-second aspect (32), forming the polymer solution into the infrared-emitting fiber according to the thirtieth aspect (30) or the thirty-first aspect (31) comprises wet spinning.

In a thirty-third aspect (33), forming the polymer solution into the infrared-emitting fiber according to the thirtieth aspect (30) or the thirty-first aspect (31) comprises dry spinning.

In a thirty-fourth aspect (34), the method according to any one of aspects (30)-(33) further comprises mixing infrared-emitting particles in the aqueous solution, the infrared-emitting particles formed of a material comprising an emissivity of greater than or equal to 0.90.

In a thirty-fifth aspect (35), the method according to any one of aspects (30)-(34) further comprises mixing a dispersant in the aqueous solution.

In a thirty-sixth aspect (36), the dispersant according to the thirty-fifth aspect (35) comprises a polyethylene wax.

A thirty-seventh aspect (37) of the present application is directed to a method of making infrared-emitting fiber, the method comprising: forming an infrared-emitting fiber comprising an emissivity of greater than or equal to 0.88; and treating the fiber with a solution comprising particles formed of a material comprising a kinetic coefficient of friction ranging from 0.1 to 0.7, wherein treating the fiber with the solution attaches the particles to the fiber.

### BRIEF DESCRIPTION OF THE FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 shows an infrared-emitting fiber according to some embodiments.

FIG. 2 shows a fabric made of thread according to some embodiments.

FIG. 3 shows a sock according to some embodiments.

FIG. 4 shows a sleeve according to some embodiments.

FIG. 5 illustrates a method of making an infrared-emitting fiber according to some embodiments.

FIG. 6 shows a schematic of methods of making an infrared-emitting fiber product according to some embodiments.

FIG. 7A is an infrared camera image of a control staple fiber sample. FIG. 7B is an infrared camera image of staple fiber composed of infrared-emitting fibers according to some embodiments.

FIG. 8 is an infrared camera image comparison of a control sock and a sock composed of infrared-emitting fibers according to some embodiments.

### DETAILED DESCRIPTION

The present application is directed to infrared-emitting fiber having the ability to absorb infrared radiation emitted from an object (for example, a human being), and emit that absorbed energy at the same, or a similar, wavelength in the infrared radiation spectrum. By absorbing and emitting infrared radiation in this fashion, the infrared-emitting fiber can be used in a textile material to absorb infrared radiation emitted from the object and emit that radiation back into the textile material. In some instances, the absorbed and re-emitted infrared radiation can be emitted back towards the object.

The capability of the infrared-emitting fiber to absorb and re-emit infrared radiation emitted from the body of a human being can be useful in harnessing the infrared energy and keeping that energy (in the form of heat) close to the body. By incorporating the infrared-emitting fiber into a textile material worn on the body, the infrared radiation emitted from the body can be harnessed to provide the therapeutic benefits, including improving microcirculation, increasing the speed of healing, increasing oxygen levels, and fighting fatigue. These therapeutic benefits can be particularly helpful for individuals living with a condition that affects blood circulation, for example diabetes. The human body emits infrared radiation at a wavelength ranging from 8 microns to 12 microns, and more specifically at a wavelength of about 9.4 microns. Accordingly, in some embodiments, the infrared-emitting fiber described herein absorbs infrared radiation having a wavelength ranging from 8 microns to 12 microns and emits infrared radiation having a wavelength ranging from 8 microns to 12 microns.

Some embodiments of the present application are directed to a method of treating poor or disrupted blood circulation, which may, for example, be a result of diabetes, by applying an article of apparel comprising the infrared-emitting fiber described herein to a body part. The body part can be, for example, a knee, an ankle, a hand, a foot, a leg, a calf, an arm, or any other suitable body part. In some embodiments, the method can include inserting the body part into an article of apparel comprising the infrared-emitting fiber. The low-friction characteristics of the infrared-emitting fiber described herein can help a wearer comfortably insert the body part into the article.

In some embodiments, infrared-emitting particles can be incorporated into the infrared-emitting fiber improve the emissive properties of the infrared-emitting fiber. However, some infrared-emitting particles have a tendency to increase the coefficient of friction for infrared-emitting fiber. This can be undesirable for a variety of reasons. First, it can create discomfort for an individual wearing an article of apparel made using the infrared-emitting fiber. Second, it can create excessive wear on manufacturing equipment used to make the infrared-emitting fiber. Third, it can make weaving or knitting the infrared-emitting fiber more difficult.

The infrared-emitting fiber described herein includes one or more low-coefficient-of-friction materials that influence the coefficient of friction of the fiber. The inclusion of one or more low-coefficient-of-friction materials can reduce at least one of the static coefficient of friction and the kinetic coefficient of friction of the fiber, relative to the same fiber without the one or more low-coefficient-of-friction materials. Because of this, the fiber can be used to make textile materials having a relatively low static and/or kinetic coefficient of friction. In some embodiments, the one or more low-coefficient-of-friction materials can have a kinetic coefficient of friction ranging from 0.1 to 0.7. In some embodiments, the one or more low-coefficient-of-friction materials can have a static coefficient of friction ranging from 0.1 to 0.7. In some embodiments, the one or more low-coefficient-of-friction materials can have a kinetic coefficient of friction ranging from 0.1 to 0.7 and a static coefficient of friction ranging from 0.1 to 0.7.

The infrared-emitting fiber described herein can comprise one or more types of particles having a suitably low coefficient of friction. These low-coefficient-of-friction particles reduce the static and/or kinetic coefficient of friction for the infrared-emitting fiber, relative to the same fiber in absence of the particles. In some embodiments, these low-coefficient-of-friction particles can have a kinetic coefficient of friction ranging from 0.1 to 0.7. In some embodiments, these low-coefficient-of-friction particles can have a static coefficient of friction ranging from 0.1 to 0.7. In some embodiments, these low-coefficient-of-friction particles can also improve the emissive properties of the infrared-emitting fiber, relative to the same fiber in absence of the particles.

In some embodiments, the infrared-emitting fiber comprises a polymer fiber composed of a polymer material. The polymer material can comprise an emissivity of greater than or equal to 0.88. One or more types of particles can be attached to the polymer. The particles can improve the emissive properties of the polymer fiber, reduce the coefficient of friction of the fiber, or both.

As used herein, “emissivity” means an object's effectiveness in emitting energy as thermal radiation. Thermal radiation is electromagnetic radiation that may include both visible radiation (light) and infrared radiation, which is not visible to human eyes. Only extremely hot objects emit thermal radiation in the form of visible light. So typically, an object's emissivity is a measure of the object's capability of emitting infrared radiation. Quantitatively, emissivity is the ratio of the thermal radiation from a surface to the radiation from an ideal black surface at the same temperature as given by the Stefan-Boltzmann law. The ratio can range from zero to one. The surface of a perfect black body (with an emissivity of 1) emits thermal radiation at the rate of approximately 448 watts per square meter at room temperature (25° C., 298.15 K). All real objects have an emissivity less than 1 and emit radiation at correspondingly lower rates. Emissivity is not a measure of an object's ability to reflect thermal radiation.

Unless specified otherwise, an emissivity value described herein is measured using Chinese Standard GB/T 30127-2013 (“Textiles: Testing and evaluation for far infrared radiation properties”). Table 3 below lists the emissivity of various exemplary materials as reported online by Optotherm Thermal Imaging in August 2020 (measurement method unknown).

The emissivity of an object can be influenced by the object's refractive index, which determines how much the path of light is bent or refracted when entering a material. This is described by Snell's law of refraction. The refractive index of an object also determines the amount of light that is reflected from the object, as well as the critical angle for total internal reflection, their intensity (Fresnel's equations), and Brewster's angle.

The refractive index of an object can vary with wavelength, and the concept of refractive index applies within the full electromagnetic spectrum, from X-rays to radio waves. For most materials, the refractive index changes with wavelength by several percent across the visible spectrum. Nevertheless, refractive indices for materials are commonly measured at 633 nanometers. Table 3 below list the refractive index measured at 633 nanometers for various exemplary materials as reported online by the International Gem Society in August 2020.

As used herein, a first component described as “attached to” a second component means that the components are attached to each other either by direct contact and/or bonding between the two components, or via an intermediate component, such as an adhesive. A first component described as “directly attached to” a second component means that the components are attached to each other by direct contact and/or bonding between the two components.

As used herein, a first component described as “embedded in” a second component means that the two components are directly attached to each other and the first component is partially or completely surrounded by the second component.

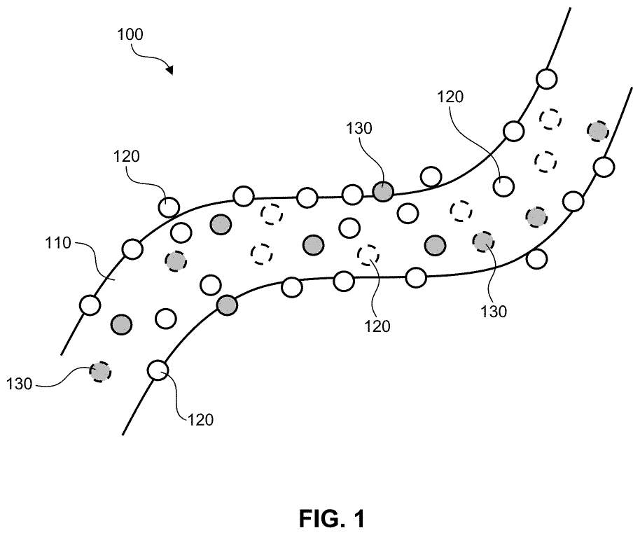

FIG. 1 shows an infrared-emitting fiber 100 according to some embodiments. Fiber 100 can include a polymer fiber 110 made of one or more polymers. In some embodiments, the one or more polymers can be a copolymer. In some embodiments, polymer fiber 110 can comprise a polymer having an emissivity of greater than or equal to 0.81. For example, in some embodiments, polymer fiber 110 can comprise a polymer having an emissivity ranging from 0.81 to 0.91 or an emissivity ranging from 0.81 to 0.99. In some embodiments, polymer fiber 110 can comprise a polymer having an emissivity of greater than or equal to 0.88. For example, in some embodiments, polymer fiber 110 can comprise a polymer having an emissivity ranging from 0.88 to 0.99. In some embodiments, polymer fiber 110 can comprise a polymer having an emissivity of greater than or equal to 0.91. For example, in some embodiments, polymer fiber 110 can comprise a polymer having an emissivity ranging from 0.91 to 0.99.

In some embodiments, polymer fiber 110 can have an emissivity of greater than or equal to 0.81. For example, in some embodiments, polymer fiber 110 can have an emissivity ranging from 0.81 to 0.91 or an emissivity ranging from 0.81 to 0.99. In some embodiments, polymer fiber 110 can have an emissivity of greater than or equal to 0.88. For example, in some embodiments, polymer fiber 110 can have an emissivity ranging from 0.88 to 0.99. In some embodiments, polymer fiber 110 can have an emissivity of greater than or equal to 0.91. For example, in some embodiments, polymer fiber 110 can have an emissivity ranging from 0.91 to 0.99.

In some embodiments, the polymer of polymer fiber 110 can include an acrylic polymer. In some embodiments, the acrylic polymer of polymer fiber 110 can include an acrylonitrile polymer, for example polyacrylonitrile. In some embodiments, the acrylic polymer of polymer fiber 110 can comprise greater than or equal to 85 wt % acrylonitrile polymer. In some embodiments, the acrylic polymer of polymer fiber 110 can include one or more comonomers, such as vinyl acetate or methyl acrylate.

In some embodiments, the polymer of polymer fiber 110 can include cellulose. In some embodiments, the polymer of polymer fiber 110 can include a polyester. In some embodiments, the polymer of polymer fiber 110 can include a nylon polymer. Exemplary nylon polymers include, but are not limited to, nylon-6 (polycaprolactam).

Infrared-emitting fiber 100 can include one or more materials attached to polymer fiber 110 and having a kinetic coefficient of friction ranging from 0.1 to 0.7. In some embodiments, infrared emitting fiber 100 can include 0.05 wt % to 1 wt % of material having a kinetic coefficient of friction ranging from 0.1 to 0.7, based on total weight of fiber 100, including subranges. For example, fiber 100 can include 0.05 wt % to 1 wt %, 0.1 wt % to 1 wt %, 0.15 wt % to 1 wt %, 0.25 wt % to 1 wt %, 0.5 wt % to 1 wt %, 0.75 wt % to 1 wt %, 0.05 wt % to 0.75 wt %, 0.05 wt % to 0.5 wt %, 0.05 wt % to 0.25 wt %, 0.05 wt % to 0.15 wt %, or 0.05 wt % to 0.1 wt % of material having a kinetic coefficient of friction ranging from 0.1 to 0.7, based on total weight of fiber 100. In some embodiments, infrared emitting fiber 100 can include 0.15 wt % to 0.75 wt % of material having a kinetic coefficient of friction ranging from 0.1 to 0.7, based on total weight of fiber 100.

Infrared-emitting fiber 100 can include one or more materials attached to polymer fiber 110 and having a static coefficient of friction ranging from 0.1 to 0.7. In some embodiments, infrared emitting fiber 100 can include 0.05 wt % to 1 wt % of material having a static coefficient of friction ranging from 0.1 to 0.7, based on total weight of fiber 100, including subranges. For example, fiber 100 can include 0.05 wt % to 1 wt %, 0.1 wt % to 1 wt %, 0.15 wt % to 1 wt %, 0.25 wt % to 1 wt %, 0.5 wt % to 1 wt %, 0.75 wt % to 1 wt %, 0.05 wt % to 0.75 wt %, 0.05 wt % to 0.5 wt %, 0.05 wt % to 0.25 wt %, 0.05 wt % to 0.15 wt %, or 0.05 wt % to 0.1 wt % of material having a static coefficient of friction ranging from 0.1 to 0.7, based on total weight of fiber 100. In some embodiments, infrared emitting fiber 100 can include 0.15 wt % to 0.75 wt % of material having a static coefficient of friction ranging from 0.1 to 0.7, based on total weight of fiber 100.

Suitable materials having a kinetic and/or static coefficient of friction ranging from 0.1 to 0.7 include, but are not limited to, boron nitride, hexagonal boron nitride, graphite, tungsten disulfide (WS₂), molybdenum disulfide (MoS₂), and polytetrafluoroethylene. In some embodiments, fiber 100 can include one of: boron nitride, hexagonal boron nitride, graphite, tungsten disulfide (WS₂), molybdenum disulfide (MoS₂), and polytetrafluoroethylene. In some embodiments, fiber 100 can include two or more of: boron nitride, hexagonal boron nitride, graphite, tungsten disulfide (WS₂), molybdenum disulfide (MoS₂), and polytetrafluoroethylene. In a preferred embodiment, fiber 100 can include hexagonal boron nitride.

Hexagonal boron nitride is a white slippery graphite-like material with a lamellar structure. The crystal lattice of hexagonal boron nitride includes hexagonal rings forming thin parallel planes. Atoms of boron (B) and nitrogen (N) are covalently bonded to other atoms in the plane with the angle 120° between two bonds (each boron atom is bonded to three nitrogen atoms and each nitrogen atom is bonded to three boron atoms). The planes are bonded to each other by weak Van der Waals forces. The layered structure allows sliding movement of the parallel planes. Weak bonding between the planes provides low shear strength in the direction of the sliding movement but high compression strength in the direction perpendicular to the sliding movement. Friction forces cause hexagonal boron nitride to orient in the direction in which the planes are parallel to the sliding movement. The anisotropy of the mechanical properties for hexagonal boron nitride imparts a combination of low coefficient of friction and high carrying load capacity. Other materials, like graphite, tungsten disulfide (WS₂), and molybdenum disulfide (MoS₂) have molecular structure and properties similar to hexagonal boron nitride.

In some embodiments, infrared-emitting fiber 100 can include particles 120 attached to the one or more polymers of polymer fiber 110 and formed of a material having a kinetic coefficient of friction ranging from 0.1 to 0.7. In some embodiments, infrared-emitting fiber 100 can include particles 120 attached to the one or more polymers of polymer fiber 110 and formed of a material having a static coefficient of friction ranging from 0.1 to 0.7.

Particles 120 formed of a material having a kinetic or static coefficient of friction ranging from 0.1 to 0.7 are referred to herein as low-coefficient-of-friction particles 120. In some embodiments, low-coefficient-of-friction particles 120 can consist essentially of a material having a kinetic or static coefficient of friction ranging from 0.1 to 0.7. In some embodiments, low-coefficient-of-friction particles 120 can consist of a material having a kinetic or static coefficient of friction ranging from 0.1 to 0.7. In some embodiments, low-coefficient-of-friction particles 120 can be embedded in the one or more polymers of polymer fiber 110. Particles 120 illustrated with broken lines in FIG. 1 are completely embedded in polymer fiber 110.

Suitable low-coefficient-of-friction particles 120 include, but are not limited to, boron nitride particles, hexagonal boron nitride particles, graphite particles, tungsten disulfide (WS₂) particles, molybdenum disulfide (MoS₂) particles, and polytetrafluoroethylene particles. In some embodiments, low-coefficient-of-friction particles 120 can include one of: boron nitride particles, hexagonal boron nitride particles, graphite particles, tungsten disulfide (WS₂) particles, molybdenum disulfide (MoS₂) particles, and polytetrafluoroethylene particles. In some embodiments, low-coefficient-of-friction particles 120 can include two or more of: boron nitride particles, hexagonal boron nitride particles, graphite particles, tungsten disulfide (WS₂) particles, molybdenum disulfide (MoS₂) particles, and polytetrafluoroethylene. Exemplary low-coefficient-of-friction particles, for example hexagonal boron nitride particles, are available from M K Impex Corp.

In some embodiments, low-coefficient-of-friction particles 120 can have a mean particle size ranging from 50 nanometers to 1 micron, including subranges. For example, in some embodiments, low-coefficient-of-friction particles 120 can have a mean particle size ranging from 50 nanometers to 1 micron, 100 nanometers to 1 micron, 250 nanometers to 1 micron, 500 nanometers to 1 micron, 750 nanometers to 1 micron, 50 nanometers to 750 nanometers, 50 nanometers to 500 nanometers, 50 nanometers to 250 nanometers, or 50 nanometers to 100 nanometers. A particle size within any of these ranges can facilitate the manufacturing of infrared-emitting fiber 100 using a wet spinning or dry spinning process. The extrusion needles used for wet spinning or dry spinning can be clogged or damaged by particles having a mean particle size greater than 1 micron.

In some embodiments, infrared emitting fiber 100 can include 0.05 wt % to 1 wt % of low-coefficient-of-friction particles 120, based on total weight of fiber 100, including subranges. For example, fiber 100 can include 0.05 wt % to 1 wt %, 0.1 wt % to 1 wt %, 0.15 wt % to 1 wt %, 0.25 wt % to 1 wt %, 0.5 wt % to 1 wt %, 0.75 wt % to 1 wt %, 0.05 wt % to 0.75 wt %, 0.05 wt % to 0.5 wt %, 0.05 wt % to 0.25 wt %, 0.05 wt % to 0.15 wt %, or 0.05 wt % to 0.1 wt % low-coefficient-of-friction particles 120, based on total weight of fiber 100. In some embodiments, infrared emitting fiber 100 can include 0.15 wt % to 0.75 wt % of low-coefficient-of-friction particles 120, based on total weight of fiber 100. More than 1 wt % of particles 120 can negatively affect the mechanical strength of fiber 100, which can lead excessive breakage during a manufacturing process used to make fiber 100, for example an extrusion process.

In some embodiments, infrared-emitting fiber 100 can include infrared-emitting particles 130 embedded in the one or more polymers of polymer fiber 110 and formed of a material having an emissivity of greater than or equal to 0.90. For example, in some embodiments, infrared-emitting particles 130 can be formed of a material having an emissivity ranging from 0.90 to 0.99. In some embodiments, infrared-emitting particles 130 can consist essentially of a material having an emissivity of greater than or equal to 0.90. In some embodiments, infrared-emitting particles 130 can consist essentially of a material having an emissivity of greater than or equal to 0.90. Particles 130 illustrated with broken lines in FIG. 1 are completely embedded in polymer fiber 110.

Suitable materials for infrared-emitting particles 130 include, but are not limited to, quartz, silicon dioxide (SiO₂), carbon, boron silicates, and aluminum oxides. In some embodiments, infrared-emitting particles 130 can include one of: quartz particles, silicon dioxide (SiO₂) particles, carbon particles, boron silicate particles, and aluminum oxide particles. In some embodiments, infrared-emitting particles 130 can include two or more of: quartz particles, silicon dioxide (SiO₂) particles, carbon particles, boron silicate particles, and aluminum oxide particles.

In some embodiments, infrared emitting fiber 100 can include 0.25 wt % to 2 wt % of infrared-emitting particles 130, based on total weight of fiber 100, including subranges. For example, fiber 100 can include 0.25 wt % to 2 wt %, 0.5 wt % to 2 wt %, 1 wt % to 2 wt %, 1.5 wt % to 2 wt %, 0.25 wt % to 1.5 wt %, 0.25 wt % to 1 wt %, or 0.25 wt % to 0.5 wt %, infrared-emitting particles 130, based on total weight of fiber 100. In some embodiments, infrared-emitting fiber 100 can include 0.5 wt % to 1.2 wt % silicone dioxide particles, based on total weight of fiber 100. In some embodiments, infrared-emitting fiber 100 can include 0.25 wt % to 0.35 wt % boron silicate particles, based on total weight of fiber 100. In some embodiments, infrared-emitting fiber 100 can include 0.25 wt % to 0.5 wt % of quartz particles, based on total weight of fiber 100.

In some embodiments, the material forming the infrared-emitting particles 130 can have a refractive index ranging from 1.37 to 1.67.

In some embodiments, infrared-emitting particles 130 can have a mean particle size ranging from 50 nanometers to 1 micron, including subranges. For example, in some embodiments, infrared-emitting particles 130 can have a mean particle size ranging from 50 nanometers to 1 micron, 100 nanometers to 1 micron, 250 nanometers to 1 micron, 500 nanometers to 1 micron, 750 nanometers to 1 micron, 50 nanometers to 750 nanometers, 50 nanometers to 500 nanometers, 50 nanometers to 250 nanometers, or 50 nanometers to 100 nanometers.

In some embodiments, infrared-emitting fiber 100 can include low-coefficient-of-friction particles 120 and infrared-emitting particles 130. In such embodiments, low-coefficient-of-friction particles 120 and infrared-emitting particles 130 can be present at any weight percentage or weight percentage range discussed herein. For example, infrared-emitting fiber 100 can include 0.05 wt % to 1 wt % of low-coefficient-of-friction particles 120, based on total weight of fiber 100, and 0.25 wt % to 2 wt % of infrared-emitting particles 130, based on total weight of fiber 100. As another example, infrared-emitting fiber 100 can include 0.15 wt % to 0.75 wt % of low-coefficient-of-friction particles 120, based on total weight of fiber 100, and 0.25 wt % to 2 wt % of infrared-emitting particles 130, based on total weight of fiber 100.

In some embodiments, infrared-emitting fiber 100 can include a dispersant. The dispersant can facilitate dispersion of low-coefficient-of-friction particles 120 within infrared-emitting fiber 100. In embodiments including infrared-emitting particles 130, the dispersant can facilitate dispersion of infrared-emitting particles 130 within infrared-emitting fiber 100. In some embodiments, the dispersant comprises a polyethylene wax. Luwax® available from BASF is an exemplary polyethylene wax that can be used as a dispersant for infrared-emitting fiber 100.

In some embodiments, infrared-emitting fiber 100 can include 2 wt % to 10 wt % of dispersant, based on total weight of fiber 100, including subranges. For example, infrared-emitting fiber 100 can include 2 wt % to 10 wt %, 4 wt % to 10 wt %, 6 wt % to 10 wt %, 8 wt % to 10 wt %, 2 wt % to 8 wt %, 2 wt % to 6 wt %, or 2 wt % to 4 wt % dispersant, based on total weight of fiber 100. In some embodiments, infrared-emitting fiber 100 can include 4 wt % to 10 wt % of dispersant, based on total weight of fiber 100.

In some embodiments, infrared-emitting fiber 100 can include low-coefficient-of-friction particles 120, infrared-emitting particles 130, and a dispersant. In such embodiments, low-coefficient-of-friction particles 120, infrared-emitting particles 130, and the dispersant can be present at any weight percentage or weight percentage range discussed herein. For example, infrared-emitting fiber 100 can include 0.05 wt % to 1 wt % of low-coefficient-of-friction particles 120, 0.25 wt % to 2 wt % of infrared-emitting particles 130, and 2 wt % to 10 wt % dispersant, all based on total weight of fiber 100. As another example, infrared-emitting fiber 100 can include 0.15 wt % to 0.75 wt % of low-coefficient-of-friction particles 120, 0.25 wt % to 2 wt % of infrared-emitting particles 130, and 2 wt % to 4 wt % dispersant, all based on total weight of fiber 100.

In some embodiments, infrared-emitting fiber 100 can include additional particles that influence the infrared-emitting properties of fiber. For example, in some embodiments, infrared-emitting fiber 100 can include infrared energy scattering particles. Exemplary infrared energy scattering particles include, but are not limited to, titanium oxide (TiO₂) particles. In some embodiments, infrared-emitting fiber can include 0.01 wt % to 0.1 wt % infrared energy scattering particles, based on total weight of fiber 100. As another example, in some embodiments, infrared-emitting fiber 100 can include infrared energy conducting particles. Exemplary infrared energy conducting particles include, but are not limited to, zirconium oxide (ZrO₂) particles. In some embodiments, infrared-emitting fiber can include 0.01 wt % to 0.1 wt % infrared energy conducting particles, based on total weight of fiber 100. In some embodiments, infrared-emitting fiber 100 can include infrared energy scattering particles and infrared energy conducting particles.

In some embodiments, infrared-emitting fiber 100 can be formed into a yarn for making a product, for example an article of apparel. In some embodiments, infrared-emitting fiber 100 can be in the form of staple fiber. In such embodiments, the staple fiber can be formed into yarn using a conventional spinning technique.

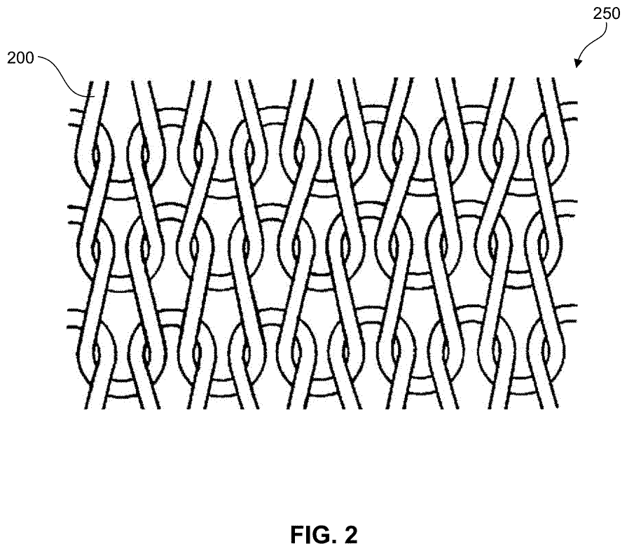

FIG. 2 shows a yarn 200 comprising infrared-emitting fiber 100 according to some embodiments. In some embodiments, yarn 200 can be formed into a fabric 250 using a technique such as weaving, knitting, spreading, felting, stitching, and/or crocheting.

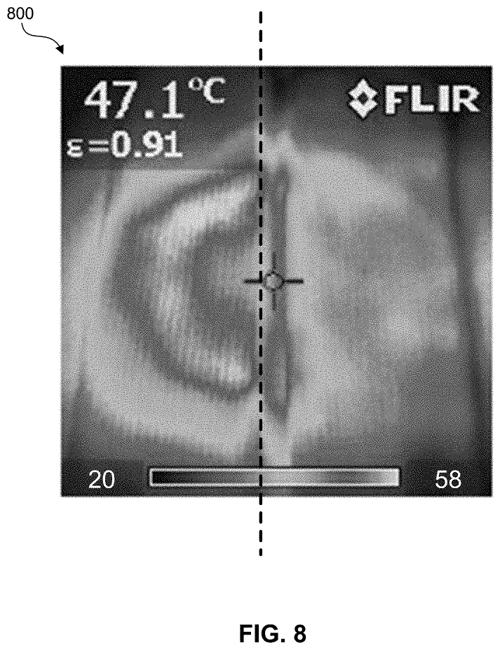

In some embodiments, fabric 250 comprising infrared-emitting fiber 100 can have an emissivity of greater than or equal to 0.88. For example, in some embodiments, fabric 250 can have an emissivity ranging from 0.88 to 0.99. In some embodiments, fabric 250 comprising infrared-emitting fiber 100 can have an emissivity of greater than or equal to 0.90. For example, in some embodiments, fabric 250 can have an emissivity ranging from 0.90 to 0.99. FIG. 8 shows an infrared camera image of a sock fabric composed of infrared-emitting fibers and having an emissivity of 0.91 according to some embodiments.

In some embodiments, fabric 250 comprising infrared-emitting fiber 100 can have at least one of a static coefficient of friction of 0.21 or less, or a kinetic coefficient of friction of 0.22 or less. In some embodiments, fabric 250 comprising infrared-emitting fiber 100 can have a static coefficient of friction of 0.21 or less. In some embodiments, fabric 250 comprising infrared-emitting fiber 100 can have a kinetic coefficient of friction of 0.22 or less. In some embodiments, fabric 250 comprising infrared-emitting fiber 100 can have a static coefficient of friction of 0.21 or less and a kinetic coefficient of friction of 0.22 or less.

In some embodiments, fabric 250 comprising infrared-emitting fiber 100 can have at least one of a static coefficient of friction of 0.22 or less, or a kinetic coefficient of friction of 0.30 or less. In some embodiments, fabric 250 comprising infrared-emitting fiber 100 can have a static coefficient of friction of 0.22 or less. In some embodiments, fabric 250 comprising infrared-emitting fiber 100 can have a kinetic coefficient of friction of 0.30 or less. In some embodiments, fabric 250 comprising infrared-emitting fiber 100 can have a static coefficient of friction of 0.22 or less and a kinetic coefficient of friction of 0.30 or less.

In some embodiments, fabric 250 comprising infrared-emitting fiber 100 can have a static coefficient of friction ranging from 0.15 to 0.21. In some embodiments, fabric 250 comprising infrared-emitting fiber 100 can have a kinetic coefficient of friction ranging from 0.15 to 0.22. Unless specified otherwise, a static coefficient of friction value and a kinetic coefficient of friction value for a fabric described herein is measured according to ASTM D1894-14 (“Static and Kinetic Coefficients of Friction of Plastic Film and Sheeting”). A static coefficient of friction is measured by testing four or more samples and averaging the results. Similarly, a kinetic coefficient of friction is measured by testing four or more samples and averaging the results.

In some embodiments, fabric 250 comprising infrared-emitting fiber 100 can have a static coefficient of friction ranging from 0.15 to 0.22. In some embodiments, fabric 250 comprising infrared-emitting fiber 100 can have a kinetic coefficient of friction ranging from 0.15 to 0.30.

In some embodiments, fabric 250 can be define all or a portion of an article of apparel. In some embodiments, the article of apparel can have a hollow shape defined by a textile material, the textile material being defined in whole or in part by fabric 250. Exemplary articles of apparel include, but are not limited to, a sock, a compression sock, a sleeve, a compression sleeve, leggings, a wrap, a hat, and a glove.

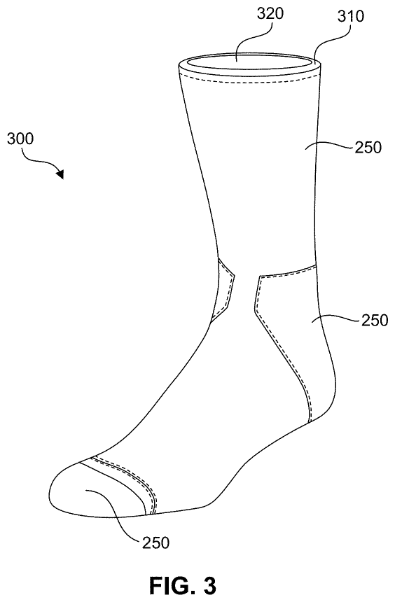

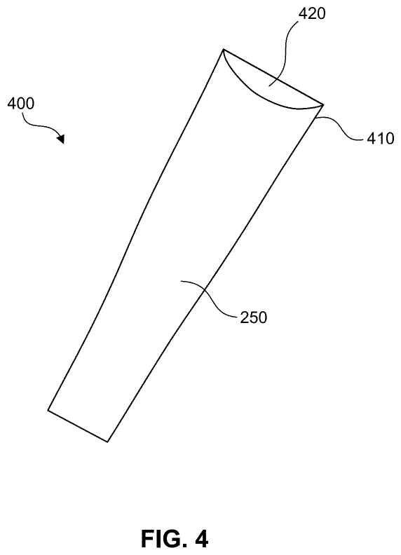

FIG. 3 shows a sock 300 according to some embodiments. In some embodiments, sock 300 can include a textile material 310 defining a hollow shape 320 and including one or more pieces of fabric 250. FIG. 4 shows a sleeve 400 according to some embodiments. Sleeve 400 can include a textile material 410 defining a hollow shape 420 and including one or more pieces of fabric 250.

Infrared-emitting fiber 100 can be made by forming a polymer fiber 110 and attaching low-coefficient-of-friction particles 120 to the polymer of the polymer fiber 110. In some embodiments, the polymer fiber 110 can have an emissivity of greater than or equal to 0.88. In some embodiments, the polymer fiber 110 can have an emissivity of greater than or equal to 0.91. In some embodiments, forming polymer fiber 110 can include embedding infrared-emitting particles 130 into polymer fiber 110.

In some embodiments, attaching the low-coefficient-of-friction particles 120 to the polymer of the polymer fiber 110 can include mixing the low-coefficient-of-friction particles 120 with a polymer precursor (for example, monomers) before or during polymerization of the polymer precursor. In such embodiments, all or a portion of the low-coefficient-of-friction particles 120 can be embedded in the polymer of the polymer fiber 110.

In some embodiments, attaching the low-coefficient-of-friction particles 120 to the polymer of the polymer fiber 110 can include treating the polymer fiber 110 with a solution comprising the low-coefficient-of-friction particles 120. In such embodiments, the low-coefficient-of-friction particles 120 can be attached to the outer surface of the polymer fiber 110. Treating the polymer fiber 110 with a solution comprising the low-coefficient-of-friction particles 120 can be achieved using similar techniques used for dye finishing a fiber. In some embodiments, the solution can include 0.17 wt % to 0.2 wt % low-coefficient-of-friction particles 120. As a non-limiting example, in some embodiments, treating the polymer fiber 110 with a solution comprising the low-coefficient-of-friction particles 120 can include: mixing a solution dye with hot water, heating the mixture to above 200° F., adding hexagonal boron nitride particles at 0.15 wt % to 0.50 wt % of the solution, adding about 0.1 wt % surfactant, soaking the fiber 110 in the solution at temperature for at least 1 hour, and removing the fiber 110 from the solution and allowing the fiber 110 to air dry.

In some embodiments, attaching the low-coefficient-of-friction particles 120 to the polymer of the polymer fiber 110 can include mixing the low-coefficient-of-friction particles 120 with a polymer precursor (for example, monomers) before or during polymerization of the polymer precursor and treating the polymer fiber 110 with a solution comprising the low-coefficient-of-friction particles 120.

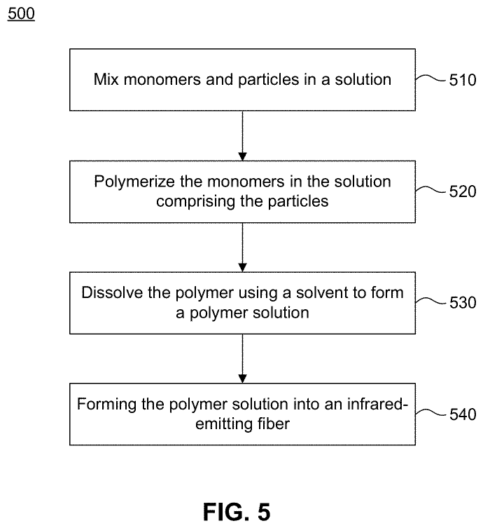

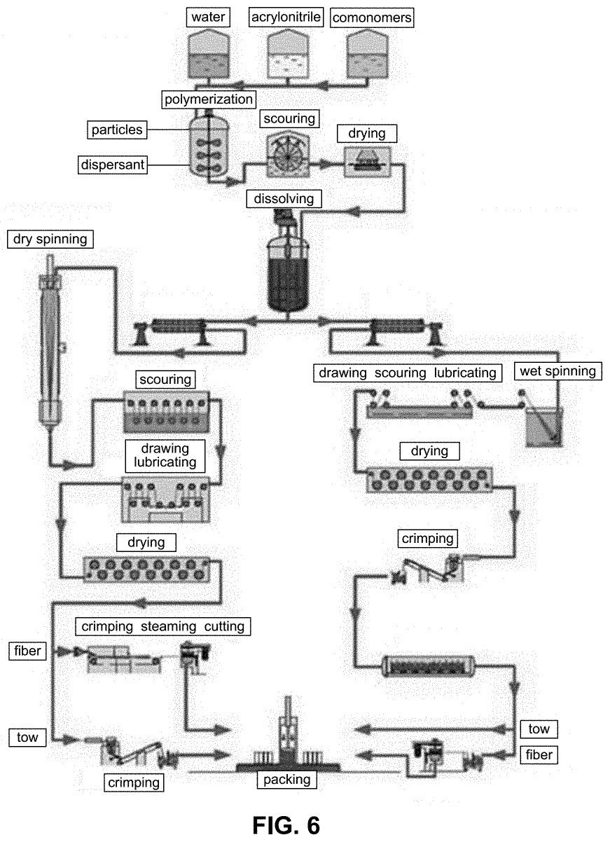

FIG. 5 shows a method 500 of making infrared-emitting fiber 100 according to some embodiments. Unless stated otherwise, the steps of method 500 need not be performed in the order set forth herein. Additionally, unless specified otherwise, the steps of method 500 need not be performed sequentially. In some embodiments, two or more of the steps can be performed simultaneously. FIG. 6 is a schematic representation 600 of method 500 according to some embodiments.

In step 510, monomers and low-coefficient-of friction particles 120 can be mixed in a solution. In some embodiments, the monomers and low-coefficient-of friction particles 120 in step 510 can be mixed in an aqueous solution. In some embodiments, monomers mixed in step 510 can be comonomers for forming a copolymer. In some embodiments, particles 120 can be dried to a moisture content of 1 wt % or less before being mixed in step 510.

In some embodiments, step 510 can include mixing infrared-emitting particles 130 in the solution. The addition of the infrared-emitting particles 130 can increase the emissive properties of the infrared-emitting fiber 100 made using method 500, relative to infrared-emitting fiber 100 without the infrared-emitting particles 130. In some embodiments, the infrared-emitting particles 130 can be formed of a material having an emissivity of greater than or equal to 0.90. In some embodiments, particles 130 can be dried to a moisture content of 1 wt % or less before being mixed in step 510.

In some embodiments, particles 120 and/or particles 130 can be mixed in the solution in step 510 at a final ratio load of 1 wt % or less. For example, particles 120 and/or particles 130 can be mixed in the solution in step 510 at a final ratio load of 0.15 wt % to 1 wt %, 0.15 wt % to 0.75 wt %, or 0.15 wt % to 0.50 wt %.

In some embodiments, step 510 can include mixing a dispersant in the solution. In some embodiments, the dispersant can include a polyethylene wax.

In step 520, the monomers in the solution including the low-coefficient-of friction particles 120 are polymerized to form a polymer. In some embodiments, the polymerization in step 520 can include free radical polymerization. In some embodiments, after the polymerization and before step 530, method 500 can include a process that scours the polymer formed in step 520. In some embodiments, after the polymerization and before step 530, method 500 can include a process that dries the polymer formed in step 520.

In step 530, the polymer formed in step 520 is dissolved using a solvent to form a polymer solution. In some embodiments, the solvent can be dimethylformamide. The polymer solution created in step 530 can be a gel-like material.

In step 540, the polymer solution is formed into infrared-emitting fiber 100. Forming the polymer solution into infrared-emitting fiber 100 can include removing the solvent from the polymer solution. In some embodiments, forming the polymer solution into infrared-emitting fiber 100 can include extruding the polymer solution using a spinneret.

In some embodiments, forming the polymer solution into infrared-emitting fiber 100 can include wet spinning the polymer solution into fiber. In some embodiments, after wet spinning, the fiber can be treated to impart desired properties to the fiber. For example, the fiber can be scoured, drawn, lubricated, stretched, and/or dried.

In some embodiments, forming the polymer solution into infrared-emitting fiber 100 can include dry spinning the polymer solution into fiber. In some embodiments, after drying spinning, the fiber can be treated to impart desired properties to the fiber. For example, the fiber can be scoured, drawn, lubricated, stretched, and/or dried.

In some embodiments, after forming fiber 100 in step 540, the fiber 100 can be processed using any number of textile processing techniques. Exemplary techniques include crimping, steaming, and cutting processes. In some embodiments, the fiber 100 can be made into tows.

The embodiments discussed herein will be further clarified in the following examples. It should be understood that these examples are not limiting to the embodiments described above.

### Example 1

An acrylic infrared-emitting fiber was made according to the following process. 95 wt % acrylonitrile and 6 wt % methyl acrylate (400 parts) were added to an aqueous solution including 0.25 wt % of potassium persulfate (K₂S₂O₈) (600 parts), 0.50 wt % Na₂S₂O₅ (sodium metabisulfite) (600 Parts), and 2N sulfuric acid (2.5 Parts) in a reaction vessel. 0.5 wt % to 1 wt % of particles, based on total weight of the solution in the reaction vessel, were fed into the reaction vessel at 52° C. under nitrogen atmosphere before polymerization. The particles included 65 wt % quartz infrared-emitting particles, 15 wt % hexagonal boron nitride particles (available from M K Impex Corp.), 10 wt % zirconium oxide particles, and 10 wt % titanium oxide particles. The mixture was allowed to polymerize in the reaction vessel and resulted in a slurry having 67 wt % polymer. The slurry was continuously withdrawn, filtered and washed until free from salts. The slurry was then dried.

The resulting acrylonitrile polymer with the infrared-emitting particles and hexagonal boron nitride particles attached thereto was then dry spun. For dry spinning, the acrylonitrile polymer was dissolved in dimethylformamide to create a polymer solution. The polymer solution was heated and extruded into a heated spinning cell. A heated evaporating medium removed the solvent during the dry spinning process. The spun fibers were hot stretched at 100° C. to 250° C. depending on the time of contact in the hot zone, to several times their original length.

### Example 2

A nylon infrared-emitting fiber was made according to the following process. 0.5 wt % to 1 wt % of particles, based on total weight of the finished fiber, were added to an aqueous solution including monomers for a nylon polymer in a reaction vessel. The particles included 65 wt % quartz infrared-emitting particles, 15 wt % hexagonal boron nitride particles (available from M K Impex Corp.), 10 wt % zirconium oxide particles, and 10 wt % titanium oxide particles. These particles were mixed into the aqueous solution at a rate of 20% by weight. 2 wt % Luwax® was also added to the solution to help lessen the agglomeration of particles during mixing. After the aqueous solution with the particles was homogeneously mixed, the mixture was allowed to polymerize in the reaction vessel. The resulting nylon polymer with the infrared-emitting particles and hexagonal boron nitride particles attached thereto was then dry spun into fibers.

The emissivity of the dry spun fibers was measured according to Chinese Standard GB/T 30127-2013 (“Textiles: Testing and evaluation for far infrared radiation properties”). The fibers had an emissivity of 0.88.

### Example 3

The static and kinetic coefficient of friction for a control infrared-emitting sock fabric obtained from Celliant® and a sock fabric made using infrared-emitting fiber according to the present application were tested according to ASTM D1894-14. The infrared-emitting fiber according to the present application was composed of fiber made according to Example 1. The fabrics were both knitted fabrics. The substrate material used for the tests was #8 mirror finish stainless steel and the testing equipment used was an Instron Series 5565. The sample types were “Plaque” and they were tested in the length direction. Samples were cut to a 2.5 inch by 2.5 inch size and conditioned for 40+ hours at 23° C.+/−2° C. and 50%+/−10% relative humidity. The samples were tested at 23° C.+/−2° C. and 50%+/−10% relative humidity. Four control samples (C1-C4) and four infrared-emitting fiber samples composed of fiber made according to Example 1 (S1-S4) were tested.

The static load and sled weight of each test is shown below in Table 1, which also reports the static coefficient of friction and the kinetic coefficient of friction measured for each sample. Samples C1-C4 had an average static coefficient of friction of 0.229 with a standard deviation of 0.010. Samples S1-S4 had an average static coefficient of friction of 0.205 with a standard deviation of 0.005. Samples C1-C4 had an average kinetic coefficient of friction of 0.249 with a standard deviation of 0.009. Samples S1-S4 had an average kinetic coefficient of friction of 0.212 with a standard deviation of 0.003.

These coefficient of friction test results show fibers according to the presentation application can be used to create a fabric having a static and/or kinetic coefficient of friction less than a commercially available infrared-emitting fabric.

TABLE 1
Coefficient of Friction Test Results for Acrylic Fiber

| Sample | Static | Sled | Static | Kinetic | Sled | Kinetic |
|---|---|---|---|---|---|---|
| No. | Load (g) | Weight(g) | COF | Load(g) | Weight(g) | COF |
| Cl | 48.5 | 200.0 | 0.243 | 52.3 | 200.0 | 0.262 |
| C2 | 44.0 | 200.0 | 0.220 | 49.3 | 200.0 | 0.247 |
| C3 | 45.1 | 200.0 | 0.226 | 49.4 | 200.0 | 0.247 |
| C4 | 45.1 | 200.0 | 0.226 | 48.1 | 200.0 | 0.241 |
| S1 | 41.5 | 200.0 | 0.208 | 42.0 | 200.0 | 0.210 |
| S2 | 41.5 | 200.0 | 0.208 | 43.2 | 200.0 | 0.216 |
| S3 | 39.5 | 200.0 | 0.198 | 42.2 | 200.0 | 0.212 |
| S4 | 41.1 | 200.0 | 0.206 | 41.5 | 200.0 | 0.208 |

### Example 4

The infrared radiation absorption capability of a control staple fiber and a staple fiber made using infrared-emitting fiber according to the present application were tested using an infrared camera. The control staple fiber was composed of 100% acrylic fiber. The infrared-emitting staple fiber according to the present application was composed of fiber made according to Example 1.

To evaluate the infrared radiation absorption capability of the staple fiber, an infrared heat source was positioned above a work area, and after a 15-minute warm up period, the fibers were placed underneath the infrared heat source in the work area. After five more minutes, the infrared camera was used measure the temperature of the fibers.

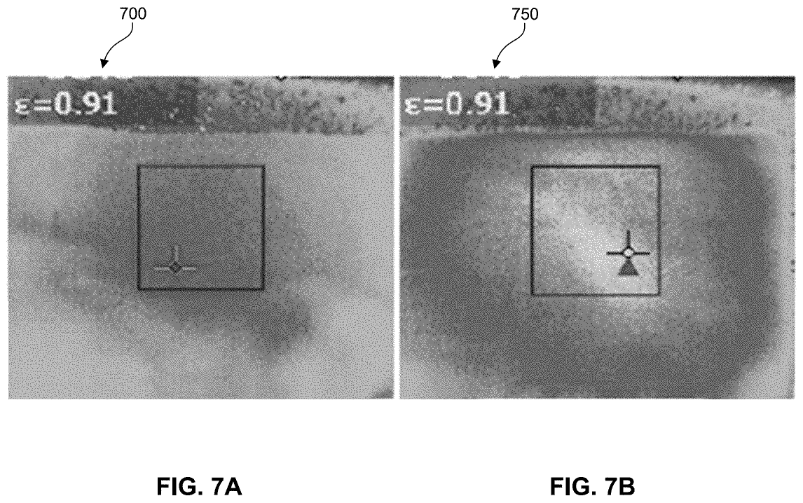

FIG. 7A shows an infrared camera image 700 of the control staple fiber. FIG. 7B shows an infrared camera image 750 of the staple fiber made with the infrared-emitting staple fiber according to the present application. These images show that the infrared-emitting staple fiber according to the present application is capable of absorbing more infrared energy from the infrared heat source than the control staple fiber, as indicated by the different color distribution in images 700 and 750. The infrared-emitting staple fiber according to the present application reached a maximum temperature of about 58° C. while the control stable fiber reached a maximum temperature of about 50° C.

The same sample fibers were made into sock materials using a knitting technique, and the infrared radiation absorption capability of the sock materials was tested. FIG. 8 shows an infrared camera image comparison 800 of a control sock and a sock composed of the infrared-emitting fibers according to the present application. The left side of the image shows the sock composed of the infrared-emitting fibers according to the present application and the right side shows the control sock. Similar to the staple fibers, this image shows that the sock fabric made with the infrared-emitting staple fiber according to the present application is superior at absorbing infrared radiation.

### Example 5

The static and kinetic coefficient of friction for knitted fabric made using the infrared-emitting fiber of Example 2 was tested according to ASTM D1894-14. The substrate material used for the tests was #8 mirror finish stainless steel and the testing equipment used was an Instron Series 5569. The sample types were “Plaque.” Samples were cut to a 2.5 inch by 2.5 inch size and conditioned for 40+ hours at 23° C.+/−2° C. and 50%+/−10% relative humidity. The samples were tested at 23° C.+/−2° C. and 50%+/−10% relative humidity. Five samples (N1-N5) were tested.

The static load and sled weight of each test is shown below in Table 2, which also reports the static coefficient of friction and the kinetic coefficient of friction measured for each sample. Samples N1-N5 had an average static coefficient of friction of 0.210 with a standard deviation of 0.015, and an average kinetic coefficient of friction of 0.286 with a standard deviation of 0.016.

TABLE 2
Coefficient of Friction Test Results for Nylon Fiber

| Sample | Static | Sled | Static | Kinetic | Sled | Kinetic |
|---|---|---|---|---|---|---|
| No. | Load (g) | Weight(g) | COF | Load(g) | Weight(g) | COF |
| N1 | 44.6 | 200.0 | 0.223 | 60.8 | 200.0 | 0.304 |
| N2 | 38.1 | 200.0 | 0.191 | 58.6 | 200.0 | 0.293 |
| N3 | 42.8 | 199.9 | 0.214 | 57.4 | 199.9 | 0.287 |
| N4 | 45.1 | 200.0 | 0.226 | 56.9 | 200.0 | 0.285 |
| NS | 39.6 | 200.0 | 0.198 | 52.0 | 200.0 | 0.260 |

### Material Property Tables

TABLE 3
Emissivity

| Material | Emissivity |
|---|---|
| Alumel (Unoxidized) | 0.10-0.25 |
| Alumel (Oxidized) | 0.60 |
| Aluminum (Polished) | 0.10-0.05 |
| Aluminum (Oxidized) | 0.10-0.40 |
| Aluminum (Rough) | 0.10-0.30 |
| Aluminum (Anodized) | 0.60-0.95 |
| Aluminum Oxide | 0.40 |
| Asbestos | 0.95 |
| Asphalt | 0.90-1.00 |
| Basalt | 0.70 |
| Bismuth | 0.50 |
| Brass (Polished) | 0.05 |
| Brass (Oxidized) | 0.50-0.60 |
| Brass (Burnished) | 0.30 |
| Carbon (Unoxidized) | 0.40-0.90 |
| Carbon (Filament) | 0.50 |
| Carbon (Soot) | 0.50-0.95 |
| Carbon (Coke) | 0.95-1.00 |
| Carbon (Graphite) | 0.70-0.80 |
| Carborundum | 0.80-0.90 |
| Ceramic | 0.90-0.95 |
| Clay (Fired) | 0.95 |
| Concrete | 0.95 |
| Chrome (Oxidized) | 0.60-0.85 |
| Chromium | 0.10 |
| Cobalt | 0.20 |
| Columbium (Polished) | 0.20 |
| Columbium (Oxidized) | 0.70 |
| Copper (Polished) | 0.10 |
| Copper (Oxidized) | 0.20-0.80 |
| Electrical terminal blocks | 0.60 |
| Enamel | 0.90 |
| Formica | 0.95 |
| Glass (Convex D) | 0.80 |
| Glass (Nonex) | 0.80 |
| Glass (Plate) | 0.90-0.95 |
| Glass (Fused quartz) | 0.75 |
| Glass (Pyrex, lead and soda) | 0.95 |
| Gold | 0.05 |
| Granite (Polished) | 0.85 |
| Granite (Rough) | 0.90 |
| Granite (Natural) | 0.95 |
| Gravel | 0.90-0.95 |
| Gypsum | 0.85-0.95 |
| Haynes Alloy | 0.30-0.80 |
| Inconel (Polished) | 0.15 |
| Inconel (Oxidized) | 0.70-0.95 |
| Inconel (Sandblasted) | 0.30-0.66 |
| Iron (Oxidized) | 0.50-0.95 |
| Iron (Rusted) | 0.50-0.70 |
| Iron (Wrought, dull) | 0.90 |
| Iron Oxide | 0.85 |
| Lacquer (Colored on Al) | 0.75-0.90 |
| Lacquer (Colored) | 0.95 |
| Lacquer (Clear on Al) | 0.10 |
| Lacquer (Clear on Cu) | 0.65 |
| Lead (Polished) | 0.05-0.10 |
| Lead (Oxidized) | 0.30-0.65 |
| Lead (Rough) | 0.40 |
| Limestone | 0.95-1.00 |
| Magnesium Oxide | 0.55 |
| Molybdenum (Polished) | 0.05 |
| Molybdenum (Oxidized) | 0.20-0.80 |
| Monel (Oxidized) | 0.45-0.85 |
| Mullite | 0.80-0.85 |
| Nichrome (Clean) | 0.65 |
| Nichrome (Oxidized) | 0.60-0.85 |
| Nickel (Polished) | 0.10 |
| Nickel (Oxidized) | 0.20-0.95 |
| Nickel Oxide | 0.60 |
| Oil (Animal/vegetable) | 0.95-1.00 |
| Oil (Mineral) | 0.90-1.00 |
| Oil (0.001” thick) | 0.25 |
| Oil (0.002” thick) | 0.46 |
| Oil (0.005” thick) | 0.70 |
| Paint (Aluminum paint) | 0.50 |
| Paint (Bronze paint) | 0.80 |
| Paint (on metal) | 0.60-0.90 |
| Paint (on plastic or wood) | 0.80-0.95 |
| Paint (Gold enamel) | 0.40 |
| Paint (Clear silicone) | 0.65-0.80 |
| Paper | 0.85-1.00 |
| Plaster | 0.90 |
| Platinum | 0.05 |
| Polyester | 0.75-0.85 |
| Polyethylene | 0.10 |
| Quartz | 0.90 |
| Roofing Paper | 0.90 |
| Rubber (Hard glossy) | 0.95 |
| Rubber (Soft rough) | 0.85 |
| Sand | 0.80-0.90 |
| Sandstone | 0.70 |
| Shale | 0.70 |
| Silica (Powder) | 0.35-0.60 |
| Silica (Glazed) | 0.85 |
| Silica (Unglazed) | 0.75 |
| Silicon Carbide | 0.80-0.95 |
| Silver | 0.05 |
| Slate | 0.70-0.80 |
| Stainless Steel (Polished) | 0.10-0.15 |
| Stainless Steel (Oxidized) | 0.45-0.95 |
| Steel (Un-oxidized) | 0.10 |
| Steel (Oxidized) | 0.70-0.95 |
| Steel (Oxidized) | 0.70-0.95 |
| Steel (Cold Rolled) | 0.70-0.90 |
| Steel (Ground sheet) | 0.40-0.60 |
| Steel (Rough surface) | 0.95 |
| Tantalum (Un-oxidized) | 0.20 |
| Tantalum (Oxidized) | 0.60 |
| Textiles (Cotton) | 0.80 |
| Textiles (Leather) | 0.95-1.00 |
| Textiles (Silk) | 0.80 |
| Textiles (Died black) | 0.98 |
| Tin (Un-oxidized) | 0.05-0.10 |
| Tungsten (Un-oxidized) | 0.05 |
| Tungsten (Filament) | 0.30 |
| Water (Liquid) | 0.90-0.95 |
| Water (Ice) | 0.95-1.00 |
| Water (Snow) | 0.80-1.00 |
| Wood (Planed) | 0.80-0.95 |
| Wood (Sawdust) | 0.75 |
| Zinc (Polished) | 0.05 |
| Zinc (Oxidized) | 0.10 |
| Zinc (Galvanized) | 0.20-0.30 |

TABLE 4
Refractive Index

| Material | Refractive Index | Double Refraction |
|---|---|---|
| Hematite | 2.940-3.220 | 0.287 |
| Cinnabar | 2.905-3.256 | 0.351 |
| Proustite | 2.881-3.084 | 0.203 |
| Pyrargyrite | 2.880-3.080 | 0.200 |
| Cuprite | 2.849 | None |
| Rutile | 2.616-2.903 | 0.287 |
| Brookite | 2.583-2.700 | 0.117 |
| Anatase | 2.488-2.564 | 0.046-0.067 |
| Diamond | 2.417-2.419 | Anomalous |
| Fabulite | 2.409 | None |
| Stibiotantalite | 2.370-2.450 | 0.080 |
| Sphalerite | 2.368-2.371 | None |
| Crocoite | 2.290-2.660 | 0.270 |
| Wulfenite | 2.280-2.400 | 0.120 |
| Tantalite | 2.260-2.430 | 0.160 |
| Linobate | 2.210-2.300 | 0.090 |
| Manganotantalite | 2.190-2.340 | 0.150 |
| Cubic zirconia (CZ) | 2.150-2.180 | None |
| Mimetite | 2.120-2.135 | 0.015 |
| Phosgenite | 2.114-2.145 | 0.028 |
| Senarmontite | 2.087 | None |
| Boleite | 2.030-2.050 | 0.020 |
| Zincite | 2.013-2.029 | 0.016 |
| Cassiterite | 1.997-2.098 | 0.096-0.098 |
| Simpsonite | 1.994-2.040 | 0.058 |
| Gadolinium gallium | 1.970-2.020 | 0.058 |
| garnet (GGG) | | |
| Sulfur | 1.958-2.245 | 0.291 |
| Bayldonite | 1.950-1.990 | 0.04 |
| Scheelite | 1.918-1.937 | 0.010-0.018 |
| Andradite garnet | 1.880-1.940 | None |
| Anglesite | 1.878-1.895 | 0.017 |
| Uvarovite garnet | 1.865 | None |
| Purpurite | 1.850-1.920 | 0.007 |
| Sphene (titanite) | 1.843-2.110 | 0.100-0.192 |
| Yttrium aluminum | 1.833-1.835 | None |
| garnet (YAG) | | |
| Zircon | 1.810-2.024 | 0.002-0.059 |
| Cerussite | 1.804-2.079 | 0.274 |
| Gahnite | 1.791-1.818 | None |
| Spessartite garnet | 1.790-1.820 | None |
| Painite | 1.787-1.816 | 0.029 |
| Monazite | 1.774-1.849 | 0.049-0.055 |
| Almandine garnet | 1.770-1.820 | None |
| Gadolinite | 1.770-1.820 | 0.01-0.04 |
| Ruby (corundum) | 1.762-1.778 | 0.008 |
| Sapphire (corundum) | 1.762-1.778 | 0.008 |
| Benitoite | 1.757-1.804 | 0.047 |
| Shattuckite | 1.752-1.815 | 0.063 |
| Chrysoberyl | 1.746-1.763 | 0.007-0.011 |
| Periclase | 1.740 | None |
| Scorodite | 1.738-1.816 | 0.027-0.030 |
| Staurolite | 1.736-1.762 | 0.010-0.015 |
| Grossular garnet | 1.734-1.759 | None |
| Chambersite | 1.732-1.744 | 0.012 |
| Hessonite garnet | 1.730-1.757 | None |
| Epidote | 1.729-1.768 | 0.015-0.049 |
| Pyroxmangite | 1.726-1.764 | 0.016-0.020 |
| Azurite | 1.720-1.848 | 0.108-0.110 |
| Pyrope garnet | 1.720-1.756 | None |
| Hodgkinsonite | 1.719-1.748 | 0.022-0.026 |
| Taaffeite | 1.719-1.730 | 0.004-0.009 |
| Rhodonite | 1.716-1.752 | 0.010-0.014 |
| Gahnospinel | 1.715-1.754 | None |
| Spinel | 1.712-1.762 | none |
| Kyanite | 1.710-1.734 | 0.015-0.033 |
| Adamite | 1.708-1.760 | 0.048-0.050 |
| Diaspore | 1.702-1.750 | 0.048 |
| Serendibite | 1.701-1.743 | 0.005 |
| Sapphirine | 1.701-1.734 | 0.004-0.007 |
| Aegirine-augite | 1.700-1.800 | 0.030-0.050 |
| Idocrase (vesuvianite) | 1.700-1.723 | 0.002-0.012 |
| Tanzanite | 1.691-1.700 | 0.009 |
| Neptunite | 1.690-1.736 | 0.029-0.045 |
| Willemite | 1.690-1.723 | 0.028-0.033 |
| Rhodizite | 1.690 | None |
| Triphylite | 1.689-1.702 | 0.006-0.008 |
| Lithiophilite | 1.680-1.700 | 0.01 |
| Dumortierite | 1.678-1.689 | 0.015-0.037 |
| Legrandite | 1.675-1.740 | 0.060 |
| Hypersthene | 1.673-1.731 | 0.010-0.016 |
| Parisite | 1.671-1.772 | 0.081-0.101 |
| Clinozoisite | 1.670-1.734 | 0.010 |
| Sinhalite | 1.665-1.712 | 0.036-0.042 |
| Lawsonite | 1.665-1.686 | 0.019-0.021 |
| Diopside | 1.664-1.730 | 0.024-0.031 |
| Bustamite | 1.662-1.707 | 0.014-0.015 |
| Kornerupine | 1.660-1.699 | 0.012-0.017 |
| Hiddenite | 1.660-1.681 | 0.014-0.016 |
| Kunzite | 1.660-1.681 | 0.014-0.016 |
| Boracite | 1.658-1.673 | 0.010-0.011 |
| Axinite | 1.656-1.704 | 0.010-0.012 |
| Malachite | 1.655-1.909 | 0.254 |
| Sillimanite | 1.655-1.684 | 0.014-0.021 |
| Jadeite | 1.652-1.688 | 0.20 |
| Peridot | 1.650-1.703 | 0.036-0.038 |
| Ludlamite | 1.650-1.697 | 0.038-0.044 |
| Enstatite | 1.650-1.680 | 0.009-0.012 |
| Euclase | 1.650-1.677 | 0.019-0.025 |
| Phenakite | 1.650-1.670 | 0.016 |
| Dioptase | 1.644-1.709 | 0.051-0.053 |
| Jet | 1.640-1.680 | None |
| Eosphorite | 1.638-1.671 | 0.028-0.035 |
| Spurrite | 1.637-1.681 | 0.039-0.040 |
| Jeremejevite | 1.637-1.653 | 0.007-0.013 |
| Barite | 1.636-1.648 | 0.012 |
| Siderite | 1.633-1.875 | 0.242 |
| Danburite | 1.630-1.636 | 0.006-0.008 |
| Clinohumite | 1.629-1.674 | 0.028-0.041 |
| Apatite | 1.628-1.649 | 0.002-0.006 |
| Andalusite | 1.627-1.649 | 0.007-0.013 |
| Friedelite | 1.625-1.664 | 0.030 |
| Smithsonite | 1.621-1.849 | 0.228 |
| Datolite | 1.621-1.675 | 0.040-0.050 |
| Celestite | 1.619-1.635 | 0.010-0.012 |
| Tourmaline | 1.614-1.666 | 0.014-0.032 |
| Actinolite | 1.614-1.653 | 0.020-0.025 |
| Hemimorphite | 1.614-1.636 | 0.022 |
| Lazulite | 1.612-1.646 | 0.031-0.036 |
| Prehnite | 1.611-1.669 | 0.021-0.039 |
| Gaspéite | 1.610-1.810 | 0.22 |
| Turquoise | 1.610-1.650 | 0.040 |
| Topaz | 1.609-1.643 | 0.008-0.016 |
| Sugilite | 1.607-1.611 | 0.001-0.004 |
| Sogdianite | 1.606-1.608 | 0.002 |
| Brazilianite | 1.602-1.623 | 0.019-0.021 |
| Rhodochrosite | 1.600-1.820 | 0.208-0.220 |
| Odontolite | 1.600-1.640 | 0.010 |
| Nephrite | 1.600-1.627 | 0.027 |
| Pectolite (larimar) | 1.595-1.645 | 0.038 |
| Montebrasite | 1.594-1.633 | 0.22 |
| Phosphophyllite | 1.594-1.621 | 0.021-0.033 |
| Meliphanite | 1.593-1.612 | 0.019 |
| Eudialyte | 1.591-1.633 | 0.003-0.010 |
| Chondrodite | 1.592-1.646 | 0.028-0.034 |
| Catapleiite | 1.590-1.629 | 0.039 |
| Wardite | 1.590-1.599 | 0.009 |
| Herderite | 1.587-1.627 | 0.023-0.032 |
| Colemanite | 1.586-1.615 | 0.028-0.030 |
| Howlite | 1.586-1.605 | 0.019 |
| Zektzerite | 1.582-1.585 | 0.003 |
| Amblygonite | 1.578-1.646 | 0.024-0.030 |
| Ekanite | 1.572-1.573 | 0.001 |
| Anhydrite | 1.570-1.614 | 0.044 |
| Augelite | 1.570-1.590 | 0.014-0.020 |
| Emerald (beryl) | 1.565-1.602 | 0.006 |
| Aquamarine (beryl) | 1.564-1.596 | 0.004-0.005 |
| Variscite | 1.563-1.594 | 0.031 |
| Beryl (precious) | 1.562-1.602 | 0.004-0.010 |
| Tremolite | 1.560-1.643 | 0.017-0.027 |
| Vivianite | 1.560-1.640 | 0.050-0.075 |
| Serpentine | 1.560-1.571 | 0.008-0.014 |
| Larbradorite | 1.559-1.570 | 0.008-0.010 |
| Hambergite | 1.553-1.628 | 0.072 |
| Pyrophyllite | 1.552-1.600 | 0.048 |
| Muscovite | 1.552-1.618 | 0.036-0.043 |
| Beryllonite | 1.552-1.561 | 0.009 |
| Charoite | 1.550-1.561 | 0.004-0.009 |
| Amethyst (quartz) | 1.544-1.553 | 0.009 |
| Aventurine (quartz) | 1.544-1.553 | 0.009 |
| Rose quartz | 1.544-1.553 | 0.009 |
| Citrine (quartz) | 1.544-1.553 | 0.009 |
| Prasiolite (quartz) | 1.544-1.553 | 0.009 |
| Smoky quartz | 1.544-1.553 | 0.009 |
| Rock crystal (quartz) | 1.544-1.553 | 0.009 |
| Andesine | 1.543-1.551 | 0.008 |
| Cordierite | 1.542-1.578 | 0.008-0.012 |
| Oligoclase | 1.542-1.549 | 0.007 |
| Talc | 1.540-1.590 | 0.050 |
| Scapolite | 1.540-1.579 | 0.006-0.037 |
| Petrified Wood | 1.540 | None |
| Jasper | 1.540 | None |
| Amber | 1.539-1.545 | None |
| Ivory | 1.535-1.570 | None |
| Apophyllite | 1.535-1.537 | 0.002 |
| Tiger's eye | 1.534-1.540 | None |
| Aragonite | 1.530-1.685 | 0.155 |
| Agate | 1.530-1.540 | 0.004-0.009 |
| Chalcedony | 1.530-1.540 | 0.004-0.009 |
| Chrysoprase | 1.530-1.540 | 0.004-0.009 |
| Moss agate | 1.530-1.540 | 0.004-0.009 |
| Sepiolite | 1.530 | None |
| Witherite | 1.529-1.677 | 0.148 |
| Milarite | 1.529-1.551 | 0.003 |
| Nepheline | 1.526-1.546 | 0.0004 |
| Sunstone | 1.525-1.548 | 0.01 |
| Amazonite | 1.522-1.530 | 0.008 |
| Pearl | 1.520-1.690 | 0.156 |
| Ammolite | 1.520-1.680 | 0.155 |
| Strontianite | 1.520-1.670 | 0.150 |
| Gypsum | 1.520-1.529 | 0.009 |
| Orthoclase | 1.518-1.530 | 0.008 |
| Sanidine | 1.518-1.530 | 0.008 |
| Moonstone | 1.518-1.526 | 0.008 |
| Pollucite | 1.517-1.525 | None |
| Carletonite | 1.517-1.521 | 0.004 |
| Stichtite | 1.516-1.544 | 0.026 |
| Thomsonite | 1.515-1.542 | 0.006-0.025 |
| Magnesite | 1.509-1.717 | 0.022 |
| Scolecite | 1.509-1.525 | 0.007-0.012 |
| Leucite | 1.504-1.509 | 0.001 |
| Mesolite | 1.504-1.508 | 0.001 |
| Dolomite | 1.502-1.698 | 0.185 |
| Petalite | 1.502-1.519 | 0.012-0.017 |
| Lapis lazuli | 1.500 | None |
| Haüyne | 1.496-1.510 | None |
| Tugtupite | 1.496-1.502 | 0.006 |
| Cancrinite | 1.495-1.528 | 0.024-0.029 |
| Celluloid | 1.495-1.520 | None |
| Ulexite | 1.491-1.520 | 0.029 |
| Yugawaralite | 1.490-1.509 | 0.011-0.014 |
| Whewellite | 1.489-1.651 | 0.159-0.163 |
| Kurnakovite | 1.488-1.525 | 0.036 |
| Inderite | 1.486-1.507 | 0.017-0.020 |
| Calcite | 1.486-1.658 | 0.172 |
| Coral | 1.486-1.658 | 0.160-0.172 |
| Moldavite | 1.48-1.540 | None |
| Natrolite | 1.480-1.493 | 0.013 |
| Sodalite | 1.480 | None |
| Analcime | 1.479-1.489 | None |
| Thaumasite | 1.464-1.507 | 0.036 |
| Creedite | 1.461-1.485 | 0.024 |
| Chrysocolla | 1.460-1.570 | 0.023-0.040 |
| Obsidian | 1.450-1.550 | None |
| Gaylussite | 1.443-1.523 | 0.080 |
| Glass | 1.440-1.900 | None |
| Fluorite | 1.434 | None |
| Sellaite | 1.378-1.390 | 0.012 |
| Opal | 1.370-1.520 | None |

The indefinite articles “a,” “an,” and “the” include plural referents unless clearly contradicted or the context clearly dictates otherwise.

The term “comprising” is an open-ended transitional phrase. A list of elements following the transitional phrase “comprising” is a non-exclusive list, such that elements in addition to those specifically recited in the list can also be present. The phrase “consisting essentially of” limits the composition of a component to the specified materials and those that do not materially affect the basic and novel characteristic(s) of the component. The phrase “consisting of” limits the composition of a component to the specified materials and excludes any material not specified.

Where a range of numerical values comprising upper and lower values is recited herein, unless otherwise stated in specific circumstances, the range is intended to include the endpoints thereof, and all integers and fractions within the range. It is not intended that the disclosure or claims be limited to the specific values recited when defining a range. Further, when an amount, concentration, or other value or parameter is given as a range, one or more ranges, or as list of upper values and lower values, this is to be understood as specifically disclosing all ranges formed from any pair of any upper range limit or value and any lower range limit or value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” refers to a value that is within ±10% of the value stated. For example, about 3 wt % can include any number between 2.7 wt % and 3.3 wt %.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

What is claimed is:

1. An infrared-emitting fiber, the fiber comprising:
a polymer comprising an emissivity of greater than or equal to 0.81; and
particles attached to the polymer and formed of a material comprising a kinetic coefficient of friction ranging from 0.1 to 0.7.

2. The infrared-emitting fiber of claim 1, wherein the polymer comprises an acrylic polymer.

3. The infrared-emitting fiber of claim 1, wherein the polymer comprises an acrylonitrile polymer.

4. The infrared-emitting fiber of claim 1, wherein the polymer comprises a nylon polymer.

5. The infrared-emitting fiber of claim 1, wherein the particles comprise particles selected from the group consisting of: boron nitride particles, graphite particles, tungsten disulfide particles, molybdenum disulfide particles, or polytetrafluoroethylene particles.

6. The infrared-emitting fiber of claim 1, wherein the particles comprise hexagonal boron nitride particles.

7. The infrared-emitting fiber of claim 1, wherein the particles comprise a mean particle size ranging from 50 nanometers to 1 micron.

8. The infrared-emitting fiber of claim 1, wherein the fiber comprises 0.05 wt % to 1 wt % of the particles, based on total weight of the fiber.

9. The infrared-emitting fiber of claim 1, wherein the fiber comprises 0.15 wt % to 0.75 wt % of the particles, based on total weight of the fiber.

10. The infrared-emitting fiber of claim 1, wherein the particles are embedded in the polymer.

11. The infrared-emitting fiber of claim 1, further comprising infrared-emitting particles embedded in the polymer and formed of a material comprising an emissivity of greater than or equal to 0.90.

12. The infrared-emitting fiber of claim 11, wherein the fiber comprises 0.25 wt % to 0.5 wt % of the infrared-emitting particles, based on total weight of the fiber.

13. The infrared-emitting fiber of claim 1, wherein the polymer comprises an emissivity of ranging from 0.81 to 0.91.

14. A yarn comprising the fiber of claim 1.

15. An article of apparel, comprising:
a fabric comprising:
infrared-emitting fiber, the fiber comprising: a polymer comprising an emissivity of greater than or equal to 0.81, and particles attached to the polymer and formed of a material comprising a kinetic coefficient of friction ranging from 0.1 to 0.7;
an emissivity of greater than or equal to 0.88; and
at least one of:
a static coefficient of friction of 0.22 or less, or
a kinetic coefficient of friction of 0.30 or less.

16. The article of apparel of claim 15, wherein the fabric comprises a kinetic coefficient of friction of 0.30 or less.

17. The article of apparel of claim 15, comprising a hollow shape defined by a textile material, wherein the fabric defines at least a portion of the textile material.

18. The article of apparel of claim 15, wherein the article comprises a sock.

19. The article of apparel of claim 15, wherein the article comprises a sleeve.

20. A method of making infrared-emitting fiber, the method comprising:
mixing monomers and particles in an aqueous solution, wherein the particles are formed of a material comprising a kinetic coefficient of friction ranging from 0.1 to 0.7;
polymerizing the monomers in the aqueous solution comprising the particles to form a polymer;
dissolving the polymer using a solvent to form a polymer solution; and
forming the polymer solution into the infrared-emitting fiber.
